(19) United States
(12) Patent Application Publication
(10) Pub. No.: US 2025/0296055 A1
(43) Pub. Date: Sep. 25, 2025

(54) Static Mixer

(71) Applicant: Atlas Copco IAS GmbH, Bretten (DE)

(72) Inventors: Martin HOCHREIN, Bretten (DE); Christian MESSENBRINK, Bretten (DE); Daeyoun SON, Bretten (DE); Julian MOTZKAU, Bretten (DE)

(21) Appl. No.: 19/076,809

(22) Filed: Mar. 11, 2025

(30) Foreign Application Priority Data
Mar. 21, 2024 (DE) 10 2024 108 124.4

(51) Int. Cl. B01F 25/431; B01F 25/312; B01F 101/00

(52) U.S. Cl. CPC B01F 25/4316; B01F 25/31252; B01F 25/431974; B01F 2101/2805

(57) ABSTRACT

A static mixer for mixing and/or activating at least one component is provided. The static mixer comprises a port for receiving a starting material containing at least the one component, a mixing chamber arranged downstream of the port, and an impact plate within the mixing chamber. A first nozzle is arranged between the port and the mixing chamber, wherein the mixing chamber is adapted to mix and/or activate an accelerated jet of the at least one component, and provide, wherein the accelerated jet impacts the impact plate.

### CROSS-REFERENCE TO RELATED APPLICATION

This application claims priority under 35 U.S.C. § 119 (a) to German Patent application No. 10 2024 108 124.4, filed on Mar. 21, 2024, which incorporated by reference herein in its entirety.

### FIELD OF INVENTION

The present invention relates to a static mixer for activating and/or mixing at least one starting material. Furthermore, the invention relates to a static mixer for mixing a 2-component bonding material, in particular 2-component foam material.

### TECHNICAL BACKGROUND

Conventional static mixers for mixing 2-component materials have the disadvantage that—depending on the material group—they often require the incorporation of an additional external dynamic mixing system or a high-pressure impact mixing system. This is accompanied by an additional input of energy into the mixing process.

Currently, mixing technologies with respective additional energy sources are used, such as e.g. dynamic mixing heads with a third valve for gas or an additional motor or a high-pressure impact mixing system. Thus, additional energy or force can be introduced into the process and consequently the injection of a 2-component (2K) foam material casting can be made possible.

Current mixing systems therefore comprise, in addition to a static mixer, additionally at least one mixing technology comprising a high-pressure impact mixing, a dynamically driven mixing in a mixing chamber, a driven mixing, wherein the static mixer comprises movable mixing elements in the mixing chamber in order to drive the starting materials, or gas-charged mixing heads.

Through the use of additional mixing technologies, not only is the energy expenditure for generating the 2K bonding material increased, but also the maintenance expenditure, in particular due to the complexity of dynamic and/or driven mixing chambers. Compared to high-pressure and/or gas-charged mixing heads, it would be desirable to reduce the process risk.

Application cases for 2K foam material castings, such as e.g. 2K polyurethane foam (TPP), can be found in particular in the automotive industry in NVH application cases (NVH stands for “noise, vibration, harshness”, i.e. “noise, vibration, roughness”).

In summary, in the prior art, no solutions for mixing and/or activating at least one component, in particular 2-component foams, such as polyurethane foam or for NVH applications are shown, which manage without movable components and/or an external input of energy.

### SUMMARY

It is therefore an object of the present invention to provide a static mixer which is suitable for mixing 2-component bonding materials and at least partially reduces the disadvantages of the conventional static mixers.

It is a further object of the invention to provide a static mixer which can independently mix and/or activate at least one component, but without movable mixing elements.

It is a further object of the invention to provide a static mixer which can independently mix and/or activate 2-component bonding materials, but without movable mixing elements.

At least one of these objects is achieved by the static mixer according to the independent claims. Advantageous developments are specified in the dependent claims.

According to one aspect of the invention, a static mixer for mixing and/or activating at least one component is provided. The static mixer comprises a port for receiving a starting material containing at least the one component, a mixing chamber arranged downstream of the port, and an impact plate or impact device within the mixing chamber. A first nozzle is arranged between the port and the mixing chamber, wherein the mixing chamber is adapted to mix and/or activate an accelerated jet of the at least one component, and provide, wherein the accelerated jet impacts the impact plate.

The port is adapted to be mounted on conventional dosing machines for starting materials containing the at least one component. In one embodiment, the port comprises a thread. Alternatively or additionally, the port can be secured by a clamping ring. The port can comprise a sealing ring. In one embodiment, the port can be formed as a mixing cup which can be connected to an external dosing machine.

The starting material contains at least one component. In one embodiment, the starting material contains two components, e.g. for a 2-component polyurethane foam. The at least one component has a high viscosity.

The nozzle accelerates the starting material after it has been received via the port due to its narrowing compared to the diameter of the receptacle. An external supply of energy is not required, apart from the injection of the starting material. In one embodiment, the nozzle is formed by a hollow cylinder. Alternatively, the nozzle can have a polygonal cross-section, in particular triangular, quadrangular, pentagonal or hexagonal. The cross-section of the nozzle defines the cross-section of the jet, which in turn can influence the mixing in the mixing chamber.

The impact plate is arranged in the propagation direction of the accelerated jet, so that the accelerated jet can impact the impact plate. The impact plate can in particular be arranged perpendicular to the longitudinal axis of the static mixer. The impact plate forms a resistance or an obstacle in the mixing chamber, in that it partially closes off or delimits the mixing chamber at its position.

During operation, the (material) jet accelerated by the nozzle impacts the impact plate, whereby the at least one component can be activated. Furthermore, the jet experiences a radial deflection, whereby the starting material can be mixed further. The mixed starting material can pass the impact plate through at least one lateral opening between the impact plate and the inner wall of the mixing chamber and can be provided by the static mixer.

A jet with a round cross-section can experience a substantially uniform radial distribution due to the impact on the impact plate. Due to an angular cross-section, the radial distribution after an impact on the impact plate can be controlled, e.g. in that more material can be transported in one corner of the jet cross-section than between two adjacent corners.

The static mixer, in particular its mixing chamber, can have a cylindrical shape, i.e. a circular cross-section. In one embodiment, the static mixer has a cross-sectional shape which is selected from a group comprising: oval, polygonal, octagonal and sectional combinations thereof.

The geometry of the impact plate can coincide with or deviate from the cross-sectional shape of the mixing chamber. In one embodiment, the impact plate has a shape which is selected from a group comprising: oval, polygonal, angular and sectional combinations thereof.

The impact plate is arranged statically in the mixing chamber. Therefore, in the static mixer according to the invention, no movable components whatsoever are required for activating and/or mixing the at least one component.

According to a further aspect of the invention, a static mixer for mixing and/or activating at least one component is provided. The static mixer comprises a port for receiving a starting material containing at least the one component, a first mixing chamber for premixing the at least one component, and a second mixing chamber arranged downstream of the first mixing chamber. The second mixing chamber comprises a first nozzle for fluid communication with the first mixing chamber. Here, the second mixing chamber is adapted to mix and/or activate an accelerated jet of the at least one premixed component, and provide.

The static mixer according to this aspect of the invention can comprise or have a port, a cross-section and an impact plate in the second mixing chamber, as described above, and process the same starting materials. In particular, the second mixing chamber according to this aspect of the invention can have the features of the mixing chamber of the above-described aspect of the invention.

The first mixing chamber can be a conventional static mixing chamber which serves for premixing the at least one component. The first mixing chamber can have an inner geometry which is selected from a group comprising: a spiral geometry, an X-shaped grid, a helical geometry, a double-spiral geometry and combinations thereof.

The first mixing chamber and the second mixing chamber are connected via the first nozzle. On the input and output side, the first nozzle can be connected to the first mixing chamber or the second mixing chamber by a first and a second conical structure, respectively. In one embodiment, the first conical structure has a first pitch and the second conical structure has a second pitch. The pitches can be adapted to the viscosity of the starting material and/or differ.

According to a further aspect of the invention, a static mixer for mixing a 2-component bonding material is provided. The static mixer comprises a port for receiving two starting materials as components, a static mixing chamber for premixing the two components, and a jet mixing chamber. The jet mixing chamber is arranged downstream of the static mixing chamber and comprises a first nozzle for fluid communication with the static mixing chamber. Here, the jet mixing chamber is adapted to mix and provide an accelerated jet of the premixed components to the 2-component bonding material.

The static mixer according to this aspect of the invention can comprise or have a port and a cross-section as described above. The first mixing chamber described according to the above aspect can be the static mixing chamber and the second mixing chamber can be the jet mixing chamber. In this respect, the static mixing chamber and the jet mixing chamber can have the above-described features.

As a 2-component bonding material, e.g. 2-component polyurethane (TPP) for NVH applications can be mixed and/or activated with the static mixer according to the invention.

The static mixer according to all the above aspects of the invention manages without an additional supply of energy or a high-pressure counter-jet and is thus more efficient and more sustainable than conventional mixing technology, in particular for 2-component bonding materials such as TPP.

In one embodiment, the static mixing chamber comprises an inner structure which brings about mixing of the starting material, i.e. the at least one component thereof. The inventors were able to establish that the mixing success of the static mixer according to the invention hardly depends on the specific configuration, i.e. diameter, length and/or inner geometry, of the static mixing chamber.

The starting material premixed in the static mixing chamber is accelerated by the first nozzle and bundled to a jet.

In one embodiment according to one of the above aspects, the longitudinal axis of the first nozzle is aligned coaxially to the longitudinal axis of the static mixer. The first nozzle can be connected to the static mixing chamber by a first conical section and can be connected to the jet mixing chamber by a second conical section.

In one embodiment according to one of the above aspects, the first conical section can have a first pitch and the second conical section can have a second pitch which is smaller than the first pitch.

In one embodiment according to one of the above aspects, the jet mixing chamber further comprises an impact plate or impact device. An impact surface of the impact plate can be arranged perpendicular to the longitudinal axis of the static mixer and/or is adapted to activate and mix the premixed components.

This impact surface also physically activates the material mixture in order to achieve the full product function of the material or starting material in the subsequent chemical curing process.

In one embodiment, the impact surface can have a microstructure in order to enable a swirling of the impinging jet along its radial propagation on the impact surface.

In one embodiment according to one of the above aspects, an axis perpendicular through the center point of the impact plate and/or the impact surface is aligned coaxially to the longitudinal axis of the first nozzle, such that the accelerated jet of the premixed components impacts the impact plate or its impact surface substantially centrally.

In one embodiment according to one of the above aspects, the impact plate and/or the impact surface is formed rotationally symmetrical. In one embodiment, the impact plate and/or the impact surface has a shape which is selected from a group comprising: oval, polygonal, angular and sectional combinations thereof.

In one embodiment according to one of the above aspects, the impact plate is fixed to an inner wall of the jet mixing chamber by at least two suspensions.

Preferably, the at least two suspensions each have a foot which is wider than the thickness of the impact plate

The foot of the at least two suspensions is adapted to absorb the shear forces arising upon impact on the impact surface. In one embodiment, the at least two suspensions further bring about a rearwardly directed guidance of the radially distributed jet, whereby better mixing of the premixed components is made possible. A portion of the radially distributed jet can pass the impact plate between the at least two suspensions. In one embodiment, the jet chamber comprises three suspensions for fixing the impact plate. The three suspensions can be arranged rotationally symmetrical with respect to the longitudinal axis of the static mixer.

In one embodiment according to one of the above aspects, the jet mixing chamber further comprises a conical tip for providing the mixed and/or activated 2-component bonding material.

Preferably, the conical tip is arranged below or behind the impact plate in the flow direction.

In one embodiment according to one of the above aspects, a second nozzle is arranged at the outlet of the static mixer, preferably on or at the conical tip. Through the second nozzle, the mixed and/or activated 2-component bonding material can be dosed in a targeted manner.

In one embodiment according to one of the above aspects, the static mixer is produced by an additive manufacturing method.

In one embodiment, the static mixer can be produced in one piece with the aforementioned elements.

The static mixer can have a plurality of lateral openings in the region of the first nozzle for removing auxiliary structures or residual materials after an execution of the additive manufacturing method.

In one embodiment, the static mixer is produced from a liquid polymer, wherein the lateral openings serve for discharging excess material during or after the production of the static mixer.

### BRIEF DESCRIPTION OF THE DRAWINGS

The invention or further embodiments and advantages of the invention are explained in more detail below with reference to drawings, wherein the drawings describe only embodiments of the invention. Identical components are provided with the same reference signs in the drawings. Elements which are drawn with dashed lines are considered to be optional elements.

The drawings are not to be regarded as true to scale, and individual elements of the drawings can be illustrated in an exaggerated large or exaggerated simplified form.

FIG. 1 shows a longitudinal section through an embodiment of the static mixer according to one aspect of the invention.

FIGS. 2A and 2B show perspective views of an embodiment of the static mixer according to one aspect of the invention.

### DETAILED DESCRIPTION

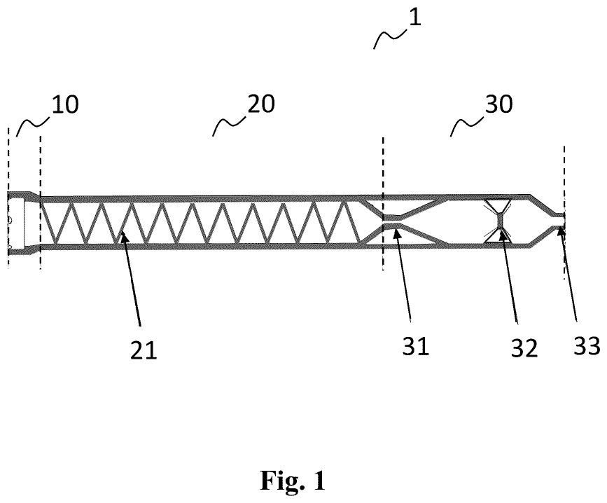

FIG. 1 shows a longitudinal section through an embodiment of the static mixer according to one aspect of the invention.

The static mixer according to FIG. 1 comprises three regions: a port 10, a first mixing chamber or static mixing chamber 20 and a second mixing chamber or jet mixing chamber 30.

The core of the invention lies in the configuration of the jet mixing chamber 30, which for fluid communication with the static mixing chamber 20 comprises at the outset a first nozzle 31 for generating an accelerated jet of the material to be mixed. The material is accelerated due to a narrowing of the first nozzle 31 compared to the cross-section of the static chamber 20 using the Bernoulli effect. Furthermore, the material or the starting material is bundled by the first nozzle 31. The jet mixing chamber 30 is adapted to mix and/or activate and provide the accelerated jet of the material. The diameter of the first nozzle 31 is to be selected in a material-specific manner.

For this purpose, an impact plate 32 can be arranged in the interior of the jet mixing chamber 30. The distance of the impact plate 32 from the first nozzle 31 and/or the diameter of the jet mixing chamber 30 or the impact plate 32 are each to be selected in a material-dependent manner.

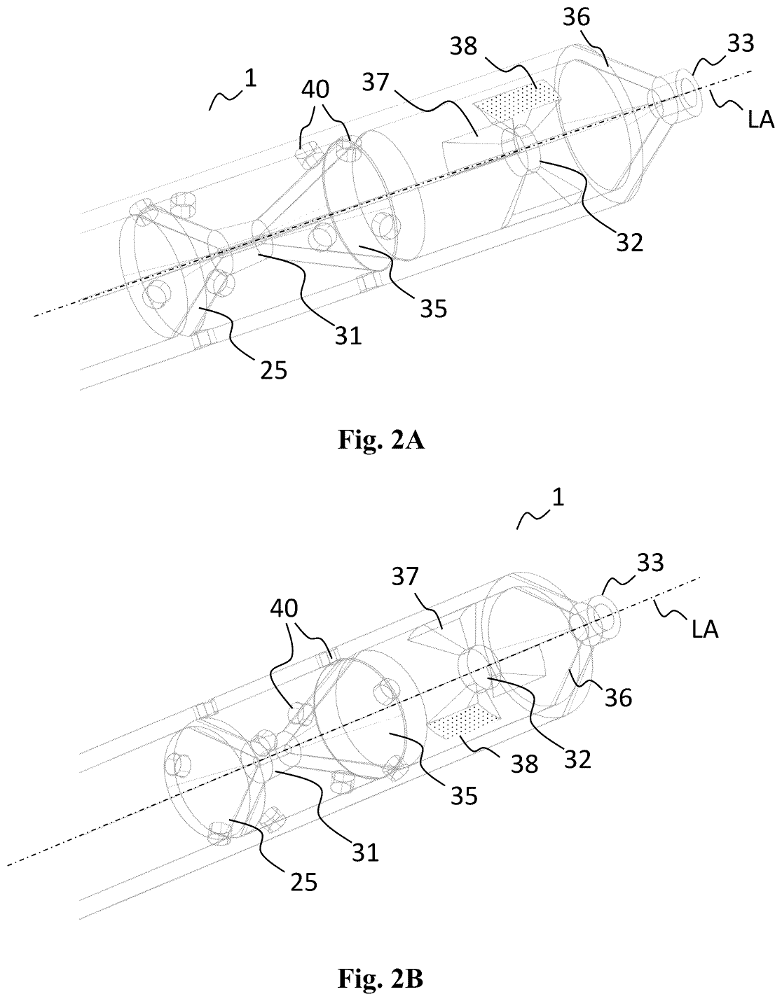

Due to the impact on the impact plate 32, the premixed at least one component can be physically activated. Furthermore, the at least one component is radially distributed along the impact plate 32 after the impact, wherein a portion of the premixed component can laterally pass the impact plate 32 after the impact through a slot between the at least two suspensions (see FIG. 2A or FIG. 2B). The other portion of the premixed component can be returned after the impact in order to be mixed further with the subsequent jet.

Downstream of the impact plate 32, a tapering of the jet mixing chamber 30 and/or a second nozzle can be provided in order to provide the mixed at least one component, in particular the mixed 2-component bonding material, such as TPP, for its application.

FIGS. 2A and 2B show perspective views of an embodiment of the static mixer according to one aspect of the invention from two different viewing angles.

In the embodiment of the static mixer 1 according to FIGS. 2A and 2B, the impact plate 32 is fixed in the interior of the jet mixing chamber 30 by three suspensions 37, such that during operation, the accelerated material jet impacts through the first nozzle 31 directly after entry into the jet mixing chamber 30.

The suspensions 37 can each have a foot 38, symbolized in FIGS. 2A and 2B by a dotted area, which has a larger area than the thickness of the impact plate 32. As a result, on the one hand, the impact plate 32 can be fixed more stably. On the other hand, as a result, a portion of the material after the impact can be returned via the suspension, i.e. guided in the direction of the first nozzle 31. The suspensions, as shown in FIGS. 2A and 2B, can thus additionally act as a guide structure for a portion of the material radially distributed after the impact, and thereby improve the mixing of the material, i.e. the components. For this purpose, the at least two suspensions can be formed substantially pyramid-shaped and/or the foot 38 thereof can have a rectangular base area, the longitudinal side of which extends parallel to the longitudinal axis LA of the static mixer 1.

FIGS. 2A and 2B likewise illustrate a plurality of lateral openings 40 which, in the region of the first nozzle 31, serve for removing auxiliary structures and/or excess polymer material during or after an additive manufacturing of the static mixer 1 from the interior thereof. In this case, no lateral opening is provided in the region of the jet mixing chamber 30 downstream of the second conical section 35.

Without any external additional input of energy and without a high-pressure counter-jet, the static mixer 1 according to one aspect of the invention can physically activate and/or efficiently mix at least one component, in particular 2-component bonding materials. The static mixer 1 according to one aspect of the invention is suitable for the use of any desired 2-component bonding materials.

### LIST OF REFERENCE NUMERALS

1 Static mixer
10 Port
20 Static mixing chamber
25 First conical section
30 Jet mixing chamber
31 First nozzle
32 Impact plate
33 Second nozzle
35 Second conical section
36 Conical tip
37 At least two suspensions
38 Foot of a suspension
40 Lateral opening
LA Longitudinal axis of the static mixer

What is claimed is:

1. A static mixer for mixing or activating at least one component, the static mixer comprising:
a port for receiving a starting material containing at least the one component,
a mixing chamber arranged downstream of the port,
an impact plate within the mixing chamber,
wherein a first nozzle is arranged between the port and the mixing chamber, wherein the mixing chamber is adapted to mix or activate an accelerated jet of the at least one component, and provide, wherein the accelerated jet impacts the impact plate.

2. The static mixer of claim 1, wherein a longitudinal axis of the first nozzle is aligned coaxially to the longitudinal axis of the static mixer, wherein the first nozzle is connected to the static mixing chamber by a first conical section and is connected to the jet mixing chamber by a second conical section.

3. The static mixer of claim 2, wherein the first conical section has a first pitch and the second conical section has a second pitch which is smaller than the first pitch.

4. The static mixer of claim 2, wherein the jet mixing chamber further comprises an impact plate, wherein an impact surface of the impact plate is arranged perpendicular to the longitudinal axis of the static mixer and is adapted to activate and mix premixed components.

5. The static mixer of claim 1, wherein an axis perpendicular through a center point of the impact plate is aligned coaxially to a longitudinal axis of the first nozzle such that the accelerated jet of premixed components impacts the impact plate substantially centrally.

6. The static mixer of claim 1, wherein the impact plate is formed rotationally symmetrical.

7. The static mixer of claim 1, wherein the impact plate is fixed to an inner wall of the jet mixing chamber by at least two suspensions, wherein the at least two suspensions each have a foot which is wider than a thickness of the impact plate.

8. The static mixer of claim 1, wherein the jet mixing chamber further comprises a conical tip for providing 2-component bonding material or the static mixer has a second nozzle for providing the 2-component bonding material.

9. The static mixer of claim 1, wherein the static mixer is produced by an additive manufacturing method, wherein the static mixer has a plurality of lateral openings in a region of the first nozzle for removing auxiliary structures after an execution of the additive manufacturing method.

10. A static mixer for mixing or activating at least one component, the static mixer comprising:
a port for receiving a starting material containing at least the one component,
a first mixing chamber for premixing the at least one component, and
a second mixing chamber arranged downstream of the first mixing chamber and comprising a first nozzle for fluid communication with the first mixing chamber, wherein the second mixing chamber is adapted to mix or activate an accelerated jet of the at least one premixed component, and provide.

11. A static mixer for mixing a 2-component bonding material, the static mixer comprising:
a port for receiving two starting materials as components,
a static mixing chamber for premixing the two components, and
a jet mixing chamber arranged downstream of the static mixing chamber and comprising a first nozzle for fluid communication with the static mixing chamber, wherein the jet mixing chamber is adapted to mix and provide an accelerated jet of the premixed components to the 2-component bonding material.
